(19) United States
(12) Patent Application Publication
(10) Pub. No.: US 2025/0276259 A1
(43) Pub. Date: Sep. 4, 2025

(54) Improved Sedimentation Tower

(71) Applicant: WYMA ENGINEERING (NZ) LIMITED, Christchurch (NZ)

(72) Inventors: Andrew James BARCLAY, Lincoln (NZ); Kent Willam STEWART, Rolleston (NZ); Timothy Clarrie PETTERSON, West Melton (NZ)

(21) Appl. No.: 18/858,730

(22) PCT Filed: Apr. 28, 2023
(86) PCT No.: PCT/IB2023/054399

§ 371 Date: Oct. 21, 2024

(30) Foreign Application Priority Data
May 2, 2022 (NZ) 787778

(51) Int. Cl. B01D 21/24; B01D 21/00

(52) U.S. Cl. CPC B01D 21/2461; B01D 21/0042

(57) ABSTRACT

A sedimentation tower which includes a tank in which the sidewalls are at an angle to the vertical in the range 0-15°, and in which the walls in at least the lower half of the tank are smooth on the interior of the tank; the tank having an inlet at one side in the upper half of the tank for the admission of wastewater to be clarified and an outlet for the discharge of clarified water at the other side of the tank, closer to the top of the tank than said inlet; the tank having at least one solids outlet in or adjacent the base of the tank, for extracting settled particles from the tank.

### TECHNICAL FIELD

The present invention relates to a sedimentation tower for settling, compacting and extracting particles in waste water. The invention has been developed with especial reference to clarifying water used for washing fruit and vegetables and therefore will be described with particular reference to that application. However, the sedimentation tower of the present invention is suitable for screening out soils and organic matter from wastewater such as dairy effluent, stormwater, mining, sewage and excavation run-off. In addition, the tower of the present invention could be used in applications where particles are suspended in a fluid other than water (e.g. as in ore purification processes).

### BACKGROUND ART

Removal of solids from wastewater is commonly a difficult process involving multiple costly steps. Current methods to settle out the solid particles into a dry manageable state commonly involves the use of lamella settling or sedimentation tanks in combination with a flocculant dosing system followed by a filter press or similar to extract the remaining water content. This equipment is typically not suited for wastewater with high solids loading and/or is expensive to set up.

In areas where space is readily available, the wastewater can be stored in settling ponds to allow solids to settle over long periods of time. Settling ponds are either dug out when they are full (with water still on the surface), and the soil left in piles to dry; alternatively, the ponds can first be drained, and then left for the soil to dry in place before the soil is dug out. Settling ponds are a viable option only if there is plenty of available space and time is not an issue; this is not always the case in urban settings.

Another known technique is to use a cyclone separator, decanter centrifuge, or a small footprint settling device such as a settling cone, to remove at least some of the larger particles from the water; if significant smaller particles remain, the water can be further processed using flocculants and/or lamella separation and/or filter presses, to remove the remaining solids. If the smaller particles are not removed, the water remains turbid with particles in it, and in many areas it is necessary to pay for disposal of such water.

All of the above mentioned types of collected solid particles are difficult to compact and extract in a relatively dry state because they tend to require a significant amount of time to settle and reach a low water content consistency:—for example, a typical settling tank for wastewater clarification is only few metres tall and/or has tapered lower section. When particles settle at the base of these tanks they experience minimal compressive loading due to the small amount of particle weight above these lower particles (defined by the height and volume of particles above the lower section) and/or the above particles are partially supported by the side walls reducing the maximum compressive force able to be loaded onto the lower section of dirt particles. This leads to an unfeasible periods of time (over 2 weeks) being required to extract the mud in a relatively dry state, and as a result the mud is commonly extracted in a slurry (with a high fluid content, greater than 40% fluid content by weight).

The problem of settling and compacting particles in wastewater has been approached in a number of ways for at least 20 years, and the equipment which has been proposed for this purpose includes both equipment for settling wastewater containing soil particles and/or organic material, and equipment for removing solids from drilling fluids predominantly when drilling oil or gas wells.

When wastewater is clarified via gravity settling it is common to collect the sediment in the base of the tank, where it is directed to an extraction mechanism. The most common method is utilising a short tank with a tapered lower section, either in a trapezoidal prism, cone, or pyramid geometry. The removal of the settled sediment is then commonly achieved through a vertical auger at the base or through lifting the settled particles above the water level. This type of geometry and mechanisms are present in prior art proposals such as GB 2006/003572, US 2003/032088.

Tapered lower sections, whilst effective in directing settled particles to a central extraction mechanism, increase frictional forces of the particles against the side walls and thus “support” the settled particles either directly through friction or via “bridging” at a higher height. This results in the lowest section of particles having a much lower compressive load than would be present with a vertical walled lower section. As the compressive load is lower, the time required to reduce the fluid content of the slurry at the base of equipment is extended significantly, and thus the slurry is commonly extracted with a high fluid content. It is sometimes possible to use vibration to move solid particles which have become lodged in a tapered settling tank, but this is noisy, introduces system wear, and is expensive.

One of the objectives to settling and extracting wastewater particles in the first place is to conserve the fluid being clarified and getting the settled particles into a manageable state, the idea being that the clarified wastewater can be reused for other purposes, and the extracted particles can be transported to another location. Thus, having the extracted particles with a high fluid content is undesirable.

Further, a slurry with a low water content can be handled as a solid and is therefore much cheaper and easier to handle than a high-fluid content slurry.

Compressing the settled particles through a vertical auger may provide some means of reducing the fluid content of the settled particles however is limited to the reactive force able to be provided by the “plug” of material blocking the outlet. As a result, the compressive forces able to be achieved will be limited to the characteristics of the slurry entering the settling tank.

Lifting the settled particles above the settling tank water does provide a means of drying the extracted particles, however, the rate at which the fluid drains from particles is relatively slow due to there being a low compressive load on the particles, and thus the particles are still likely to be handled as a high-fluid content slurry when extracted and handled further.

The height of the settled particles, and thus the height of the settling tanks does not appear to be of importance in the forementioned patents. This results in a lower compressive load being able to be achieved on the lower section of particles prior to the slurry having to be extracted due to reaching capacity. As a result, the lower section of particles experiences only a short period of time with a relatively low compressive load. This ultimately results in only a low amount of fluid able to be compressed out of the settled particles prior to extraction.

A further feature of a number of the prior-art proposals is that waste water to be processed in a settling tank is admitted through an inlet well below the top of the tank, presumably to reduce the distance that solids settling out of the inlet water have to travel. However, this arrangement limits the volume of solids which can be accumulated at the bottom of the tank without a risk of the solids blocking the inlet, and thus reduces the overall efficiency of the tank.

### DISCLOSURE OF INVENTION

An object of the present invention is the provision of a sedimentation tower suitable for extracting settled particles in a very low fluid content such that the resulting settled particles can be handled as a solid.

The present invention provides a sedimentation tower which includes:
a tank in which the sidewalls are at an angle to the vertical in the range 0-15°, and in which the walls in at least the lower half of the tank are smooth on the interior of the tank;
the tank having an inlet at one side in the upper half of the tank for the admission of wastewater to be clarified and an outlet for the discharge of clarified water at the other side of the tank, closer to the top of the tank than said inlet;
the tank having at least one solids outlet in or adjacent the base of the tank, for extracting settled particles from the tank.

Preferably, the tower also includes a series of augers arranged in parallel, placed over the base of the tank, wherein the augers cover substantially the entire base of the tank;

said at least one solids outlet being aligned with said augers; the direction of rotation of the augers in use being such that settled particles in the base of the tank are moved towards the outlet by rotation of the augers.

Preferably, the height of the tank is significantly greater than the length or width of the tank. Most preferably, the height of the tank is at least twice the length or the width.

Preferably also, a significant height of settled particles (e.g. over 2 metres) is able to be stored in the tank.

In one embodiment of the invention, the tank has a baffle near the inlet of the wastewater to slow down the wastewater flow and encourage settling of the particles prior to reaching the tank clarified water outlet.

In another embodiment, the tank has a lamella pack placed in this top section and the water is forced to go up through the pack prior to reaching the outlet, accelerating the settling process.

Preferably, at least one of the augers is adapted to measure the viscosity of the surrounding settled particles when the auger is rotated.

### BRIEF DESCRIPTION OF DRAWINGS

By way of example only, a preferred embodiment of the invention is described in detail, with reference to the accompanying drawings, in which:—

FIG. 1 is a side view of a sedimentation tower in accordance with the first embodiment of the present invention;

FIG. 2 is a longitudinal section through the tower of FIG. 1 along line 2-2 in FIG. 1;

FIG. 3 is a plan view of the augers at the base of the tank of FIG. 1;

FIG. 4 is an end view of the lower part of the tank, in the direction of arrow A (FIG. 1);

FIG. 5 is a perspective view of the lower part of the tank of FIG. 1; and

FIG. 6 is a side view of a sedimentation tower in accordance with a second embodiment of the invention.

### BEST MODE FOR CARRYING OUT THE INVENTION

Referring to the drawings, a sedimentation tower 10 in accordance with the present invention includes a tank 11 which is closed at the base 12 and at the top 13. The tank 11 is mounted on a series of spaced supporting legs 11a. Near the top 13 of the tank, there is an outlet 14 for clarified water (i.e. water from which a major part of the entrained solids have settled out), and lower down the height of the tank there is an inlet 15 for waste water to be clarified (i.e. water carrying a burden of entrained solids).

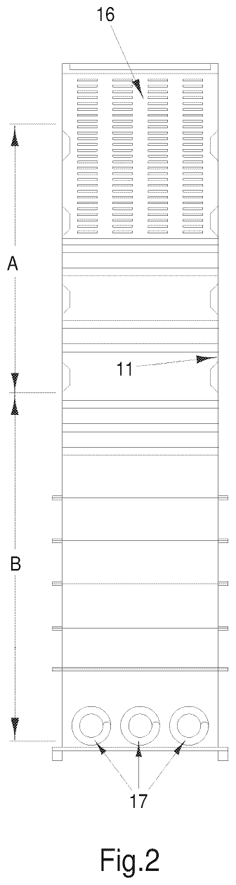

As shown in FIG. 2, a baffle 16 is fitted in the interior of the tank 11, with the plane of the baffle 16 parallel to the plane of the side wall. The baffle 16 is an apertured plate and is fitted in the tank 11 spaced a short distance away from the opening of the inlet 15 into the tank. The purpose of the baffle is to disperse the incoming wastewater, and reduce the flow of wastewater across to the clarified water outlet 14.

As an alternative to the baffle 16, a series of lamella packs (not shown) may be located in the tank above the inlet 15 but below the outlet 14. Any of a wide variety of lamella packs (all known designs) may be used. This aids the settling process for the entrained particles, and water must rise through the lamella packs to reach the outlet 14.

Once wastewater enters the tank 11 through the inlet 15, the entrained solid particles in the wastewater gradually sink to the base of the tank and build up there.

The internal walls of the upper part A of the tank may be folded (not shown) for additional strength, but the internal walls of the lower part B of the tank always are flat, to reduce the risk of particles lodging or bridging on the tank walls. Preferably, all of the internal walls are flat and smooth.

It is envisaged that it might be possible for the internal walls to be inclined at an angle to the vertical in the range 0-15°. Another possibility is that two opposed internal walls should be inclined somewhat towards each other, with the remaining two walls substantially vertical. A further possibility is a conical tapered section, with a taper angle of 15° or less.

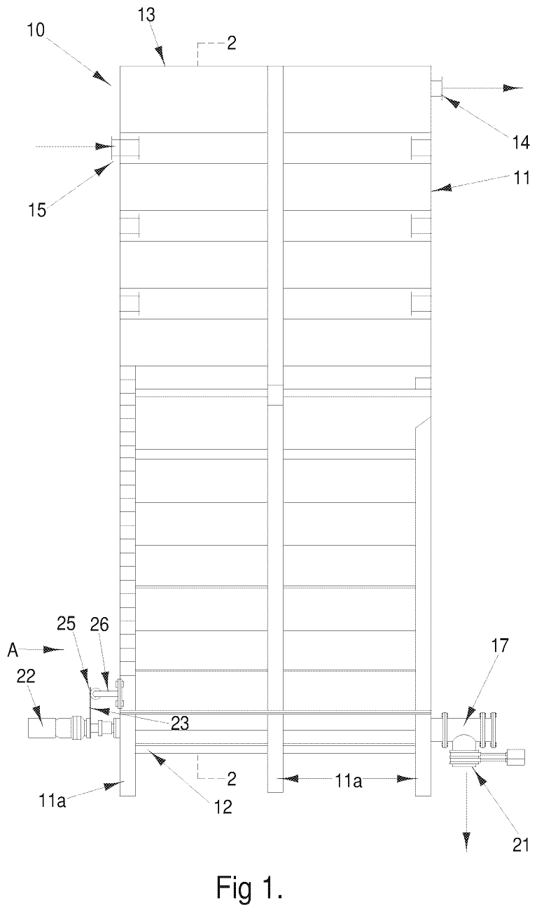

A series of spaced parallel augers 17 are positioned across the interior of the base of the tank, with the longitudinal axes of the augers parallel and substantially perpendicular to the height of the tank. Three augers 17 are shown, but in practice the number of augers used will depend on the size of the base of the tank:—the objective is that the base of the tank is substantially covered by the augers. Each auger 17 is formed in known manner, with a central shaft 18 supporting a helical screw thread 19. The augers 17 are arranged such that rotation of the augers will move solids deposited in the interior of the tank in the direction of arrow A (FIG. 1), towards solids outlets 21 mounted at the side of the tank 11, just above the base 12.

It is envisaged that it may be possible for the tank walls to be formed into a V shaped taper just above each auger, to channel the mud towards the augers. A taper of this type could be employed to reduce the overall number of augers needed.

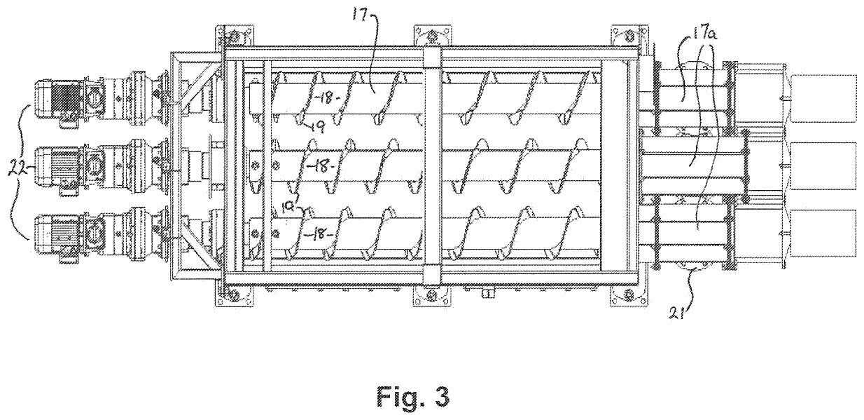

A separate solids outlet 21 is provided for each auger 17. As shown in FIG. 3, each auger 17 extends the full length of the base of the tank. One end of each auger 17 is provided with a separate motor 22 and at the opposite end of each auger, the end 17a projects through a hole (not shown) in the wall of the tank. The portion of each auger between the end 17a and the outer wall of the tank extends over the corresponding solids outlet 21, such that solids carried by each auger move across the length of the base of the tank and then fall into the corresponding outlet 21. The outlets 21 can be remotely opened and closed and may be connected to a collector or a conveyor (not shown) for removing the solids extracted from the tank.

The tank of the present invention is designed so that solids are removed from the tank only when they reaches a specific level of compaction, so that the solids are “dried” to a specified level before they are removed. It will be appreciated that handling dry or semidry solids is much easier, more efficient and cost effective than handling a sludge which has a high fluid content.

The augers 17 are designed so that they not only remove solids from the tank, but they also check the viscosity of the solids before the solids are removed. The lower the fluid content of the solids, the higher the viscosity of the solids will be, and the augers are used to estimate this viscosity by mounting a motor torque arm 23 on the motor mounting flange of each of the motors 22. Each torque arm 23 is formed at its upper end with two opposed contact faces 24; the torque arm 23 is mounted with the contact faces 24 one on each side of a load cell 25 which is mounted on a support bracket 26.

Thus, once solids have accumulated in the bottom of the tank 11, the motors 22 can be activated to rotate each of the corresponding augers 17, and the reactive load torque experienced by each of the augers is measured by the force of the contact faces 24 on the corresponding load cell 25. The load cells 25 provide a measurement of motor torque required to rotate the auger at a known rotational speed in the given mud viscosity. The measured motor torque is proportional to the given mud viscosity, and thus provides a means for determining the mud viscosity.

The load cells/torque arm system for measuring the solids viscosity can be replaced by any of a range of known torque measurement systems e.g. strain gauges on the drive shaft or a torque measuring system which derives the torque directly from the motor current.

As soon as the solids viscosity reaches a preset level, the augers 17 are rotated and the mud outlet 21 is opened, so that solids are removed from the base of the tank. The solids viscosity is monitored so that as the viscosity drops (i.e. the fluid content of the solids increases) the solids outlets 21 are closed. The augers 17 are rotated only intermittently, to check if the appropriate viscosity has been achieved for extraction.

The tank 11 is shown as rectangular in cross-section, but need not be:—the tank can be any cross-sectional shape (e.g. circular) providing the tank is straight sided and the interior surfaces of the tank walls are smooth, at least in the lower part of the tank. A tank with protrusions on the interior walls, will increase the frictional forces of the entrained particles against the side walls, and thus reduce the effective compressive load on the lower sections of solids.

Whatever cross-sectional shape of tank is selected, it is important that substantially all of the base of the tank can be provided with augers, to avoid any dead spots from which solids cannot be removed. For this reason, a rectangular cross-section tank generally is the most convenient.

One design of tank which has proved to be effective has a height of 5.3 m, and is rectangular in cross-section with a length of 2.2 m and a width of 1 m. Preferably, before the solids are removed from the base of the tank, the augers 17 measure a viscosity greater than 100,000 Pa·s.

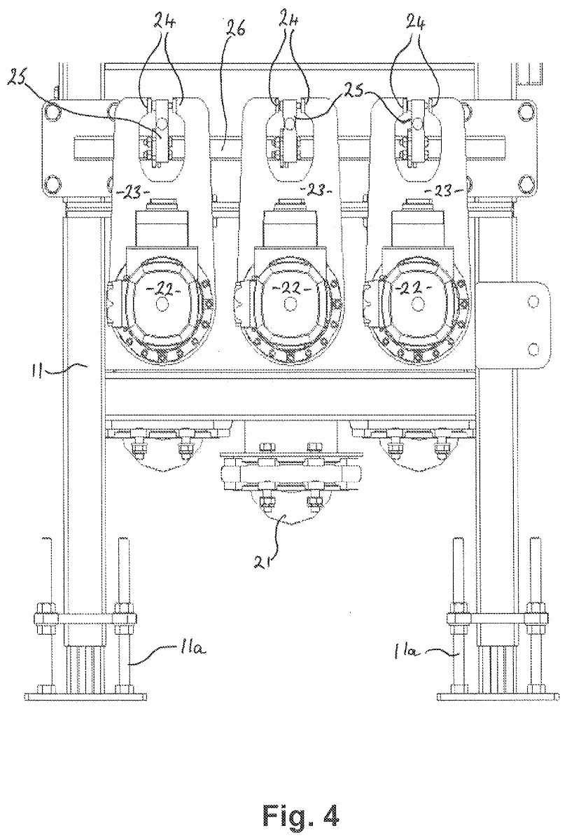

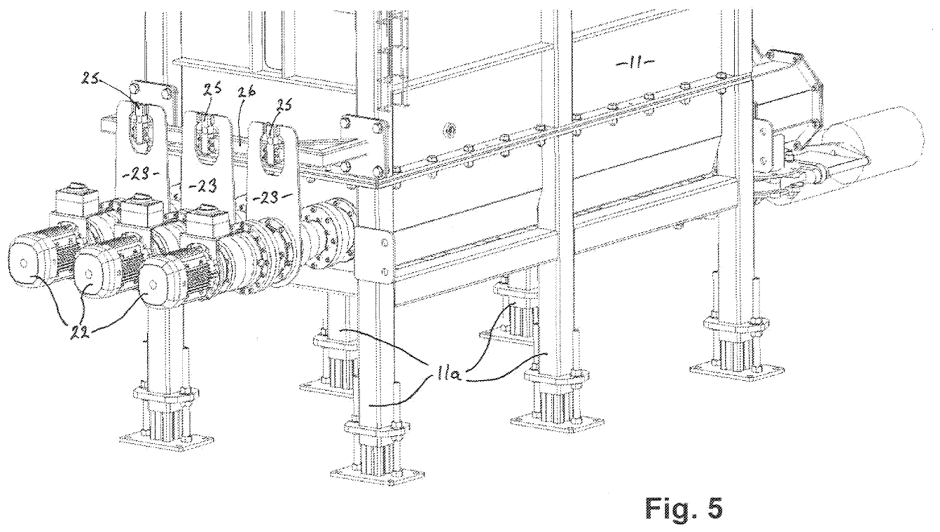

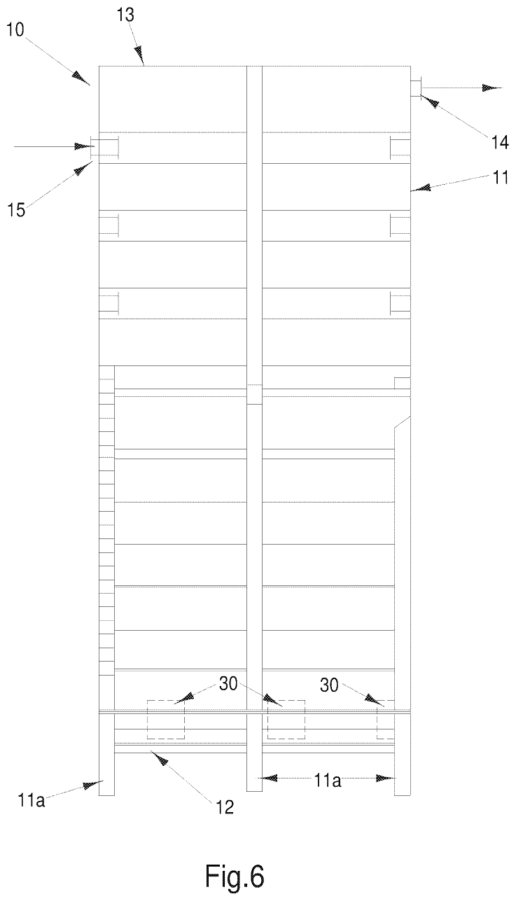

A second embodiment of the tank of the present invention is shown in FIG. 6. In this embodiment, the tank 11 base 12, supporting legs 11a and top 13 are the same as the embodiment described with reference to FIGS. 1-5. However, the base of the interior of the tank is not fitted with augers as described with reference to FIGS. 1-5, but instead, the sides and/or base of the tank adjacent the base are fitted with a series of ports 30 through which solids can be extracted from the base of the tank. The ports can be closed off by any suitable means e.g. a removable plate or pneumatic knife valve. It is envisaged that once the ports are opened, the solids may be extractable from the tank without mechanical assistance.

It is envisaged that the proportions and shape of the tank 11 will be important in achieving a satisfactory fluid content of the entrained solids in a reasonably short time, the reasoning being that the higher the tank in proportion to the area of the base of the tank, the greater the compressive load exerted by the particles in the upper part of the tank on the mud accumulating in the lower part of the tank. This compressive load effectively squeezes the water out of the accumulated solids.

1. A sedimentation tower which includes:
a tank having an interior, sidewalls, an inlet for receiving wastewater, and an outlet for discharging clarified water, in which the sidewalls are at an angle to the vertical in the range 0-15°, and in which the sidewalls in at least a lower half of the tank are smooth on the interior of the tank;
the tank having the inlet at one side in an upper half of the tank for the admission of the wastewater to be clarified and the outlet for the discharge of the clarified water at an other side of the tank, closer to a top of the tank than said inlet;
the tank having at least one solids outlet in or adjacent a base of the tank, for extracting settled particles from the tank.

2. The sedimentation tower as claimed in claim 1, further including a series of augers arranged in parallel, placed over the base of the tank, wherein the augers cover substantially the entire base of the tank; said at least one solids outlet being aligned with said augers; the direction of rotation of the augers in use being such that the settled particles in the base of the tank are moved towards the outlet by rotation of the augers.

3. The sedimentation tower as claimed in claim 2, wherein one of said augers can measure the viscosity of the material being moved by said auger in use.

4. The sedimentation tower as claimed in claim 1, further including a baffle in the tank adjacent the inlet, to slow down and disperse an inlet flow of wastewater in use.

5. The sedimentation tower as claimed in claim 4, wherein the baffle has a plane that is substantially parallel to a plane of the sidewalls adjacent wall the baffle.

6. The sedimentation tower as claimed in claim 1, further including a lamella pack positioned adjacent the outlet such that the clarified water passing through the outlet flows through said lamella pack.

7. The sedimentation tower as claimed in claim 1, wherein said at least one solids outlet can be opened and closed remotely.

8. The sedimentation tower as claimed in claim 1, wherein the tank is of rectangular cross-section.

9. The sedimentation tower as claimed claim 1, wherein the tank has a height that is at least twice the length or the width of the tank.

10. A sedimentation tower which includes:
a tank having sidewalls at an angle to the vertical in the range 0-15°, and in which the sidewalls in at least a lower half of the tank are smooth on an interior of the tank;
the tank having an inlet at one side of an upper half of the tank for the admission of wastewater to be clarified and an outlet for the discharge of clarified water at an other side of the tank, closer to a top of the tank than said inlet;
the tank having at least one solids outlet in or adjacent the base of the tank, for extracting settled particles from the tank;
a series of augers arranged in parallel, placed over a base of the tank, wherein the augers cover substantially the entire base of the tank; said at least one solids outlet being aligned with said augers; the direction of rotation of the augers in use being such that settled particles in the base of the tank are moved towards the outlet by rotation of the augers.

11. The sedimentation tower as claimed in claim 10, further including a baffle in the tank adjacent the inlet, to slow down and disperse flow at the inlet.

12. The sedimentation tower as claimed in claim 10, further including a lamella pack positioned adjacent the outlet so that flow passing through the outlet moves through said lamella pack.

13. The sedimentation tower as claimed in claim 10, wherein the tank is of rectangular cross section.

14. The sedimentation tower as claimed in claim 10, wherein the height of the tank is at least twice the length or width of the tank.
